(19) United States
(12) Patent Application Publication
(10) Pub. No.: US 2026/0344800 A1
(43) Pub. Date: Nov. 5, 2026

(54) METHOD OF MANUFACTURING AN AEROSOL GENERATING DEVICE

(71) Applicant: KT&G CORPORATION, Daejeon (KR)

(72) Inventors: Sangkyu PARK, Seoul (KR); Sunghwan KIM, Seoul (KR)

(73) Assignee: KT&G CORPORATION, Daejeon (KR)

(21) Appl. No.: 19/111,843

(22) PCT Filed: Sep. 18, 2023
(86) PCT No.: PCT/KR2023/014044

§ 371 Date: Mar. 14, 2025

(30) Foreign Application Priority Data
Sep. 19, 2022 (KR) 10-2022-0118188
Dec. 27, 2022 (KR) 10-2022-0185479

(51) Int. Cl. A24F 40/70; A24F 40/20; A24F 40/46

(52) U.S. Cl. CPC A24F 40/70; A24F 40/46; A24F 40/20

(57) ABSTRACT

An aerosol generating device and a method of manufacturing the aerosol generating device are provided. According to an aspect of an example embodiment, there is provided a method of manufacturing an aerosol generating device including a heater inserted into an elongated heater pin. The method includes: injecting a bonding material in a liquid state into a cavity of the heater pin; inserting the heater into the cavity; reducing bubbles in the bonding material while the bonding material is still in the liquid state; and solidifying the bonding material into a solid state to secure the heater in the heater pin.

### TECHNICAL FIELD

The present disclosure relates to an aerosol generating device and a method of manufacturing the aerosol generating device.

### BACKGROUND ART

An aerosol generating device is a device that extracts certain components from a medium or a substance by forming an aerosol. The medium may contain a multi-component substance. The substance contained in the medium may be a multi-component flavoring substance. For example, the substance contained in the medium may include a nicotine component, an herbal component, and/or a coffee component. Recently, various research on aerosol generating devices has been conducted.

### DISCLOSURE OF INVENTION

### Technical Problem

It is an objective of the present disclosure to solve the above and other problems.

It is another objective of the present disclosure to reduce the formation of voids in a heater pin.

It is yet another objective of the present disclosure to improve the heat conduction efficiency of a heater.

It is yet another objective of the present disclosure to prevent water or moisture from entering the inside of a heater pin.

It is yet another objective of the present disclosure to improve the structural stability of a heater assembly.

### Solution to Problem

According to one aspect of the subject matter described in this application, there is provided a method of manufacturing an aerosol generating device including a heater inserted into an elongated heater pin. The method includes: injecting a bonding material in a liquid state into a cavity of the heater pin; inserting the heater into the cavity; reducing bubbles in the bonding material while the bonding material is still in the liquid state; and solidifying the bonding material into a solid state to secure the heater in the heater pin.

### Advantageous Effects of Invention

According to at least one of the embodiments of the present disclosure, the formation of voids in a heater pin may be reduced.

According to at least one of the embodiments of the present disclosure, the heat conduction efficiency of a heater may be improved.

According to at least one of the exemplary embodiments of the present disclosure, water or moisture may be prevented from entering the inside of a heater pin.

According to at least one of the embodiments of the present disclosure, the structural stability of a heater assembly may be improved.

Further scope of applicability of the present disclosure will become apparent from the following detailed description. However, it should be understood that the detailed description and specific embodiments such as preferred embodiments of the present disclosure are given by way of example only, since various changes and modifications within the idea and scope of the present disclosure may be clearly understood by those skilled in the art.

### BRIEF DESCRIPTION OF DRAWINGS

FIGS. 1 to 20 illustrate examples of an aerosol generating device according to embodiments of the present disclosure.

### MODE FOR THE INVENTION

Description will now be given in detail according to exemplary embodiments disclosed herein, with reference to the accompanying drawings. For the sake of brief description with reference to the drawings, the same or equivalent components are provided with the same or similar reference numerals, and description thereof will not be repeated.

In the following description, a suffix such as “module” and “unit” may be used to refer to elements or components. Use of such a suffix herein is merely intended to facilitate description of the specification, and the suffix itself is not intended to give any special meaning or function.

In the present disclosure, that which is well known to one of ordinary skill in the relevant art has generally been omitted for the sake of brevity. The accompanying drawings are used to help easily understand the technical idea of the present disclosure and it should be understood that the idea of the present disclosure is not limited by the accompanying drawings. The idea of the present disclosure should be construed to extend to any alterations, equivalents, and substitutes besides the accompanying drawings.

It will be understood that although the terms “first”, “second”, etc. may be used herein to describe various elements, these elements should not be limited by these terms. These terms are only used to distinguish one element from another.

It will be understood that when a component is referred to as being “connected to” or “coupled to” another component, it may be directly connected to or coupled to another component, or intervening components may be present. On the other hand, when a component is referred to as being “directly connected to” or “directly coupled to” another component, there are no intervening components present.

As used herein, a singular representation is intended to include a plural representation unless the context clearly indicates otherwise.

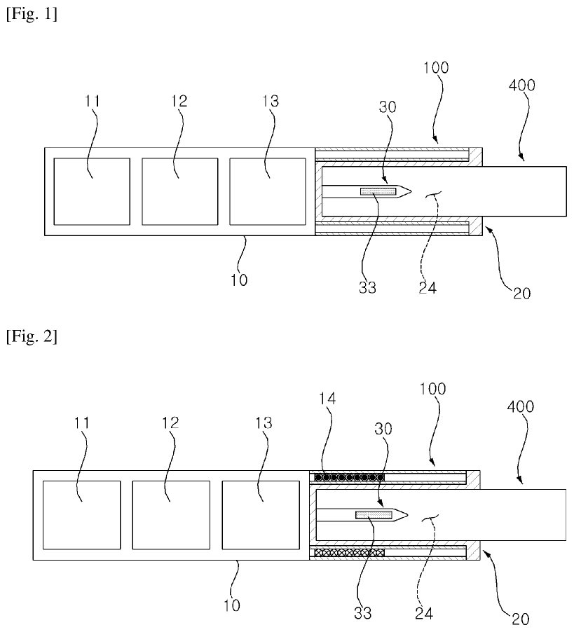

Referring to FIGS. 1 to 3, an aerosol generating device 100 may include at least one of a battery 11, a controller 12, and a sensor 13. At least one of the battery 11, the controller 12, and the sensor 13 may be disposed inside a body 10 of the aerosol generating device 100.

A pipe 20 may be coupled to an upper side of the body 10. The pipe 20 may have an insertion space 24 therein. The insertion space 24 may be open at top. The insertion space 24 may have a cylindrical shape. A stick 400 may be detachably inserted into the insertion space 24.

A heater 33 may be disposed inside a heater pin 30 protruding upward from a cover 25, which defines a bottom of the pipe 20, toward the insertion space 24. The heater 33 may be a resistive heater. The heater 33 may heat the stick 400 inserted into the insertion space 24.

When the stick 400 is inserted into the insertion space 24, one end of the stick 400 may be exposed outward of the insertion space 24 and the body 10. When the stick 400 is inserted into the insertion space 24, the heater 33 may pass through an end portion of the stick 400 to be inserted into the stick 400. The stick 400 may be heated by the heater 33. A user may inhale air while holding the one end of the stick 400 exposed to the outside in his or her mouth.

The battery 11 may supply power to operate components of the aerosol generating device 100. The battery 11 may supply power to at least one of the controller 12, the sensor 13, an induction coil 14, and the heater 33. The battery 11 may supply power required for a display, a motor, and the like installed at the aerosol generating device 100 to operate.

The controller 12 may control the overall operation of the aerosol generating device 100. The controller 12 may control the operation of at least one of the battery 11, the induction coil 14, and the sensor 13. The controller 12 may control the operation of the display, the motor, and the like installed at the aerosol generating device 100. The controller 12 may check the state of each of the components of the aerosol generating device 100 to determine whether the aerosol generating device 100 is in an operable state.

The sensor 13 may sense a temperature of the heater 33. The controller 12 may control the temperature of the heater 33 based on the temperature of the heater 33 sensed by the sensor 13. The controller 12 may transmit, through a user interface, information regarding the temperature of the heater 33 sensed by the sensor 13 to a user.

Referring to FIG. 1, the heater 33 may be electrically connected to the battery 11. The heater 33 may generate heat directly by the use of a current supplied from the battery 11, without the need for the induction coil 14 (see FIG. 2).

Referring to FIG. 2, the aerosol generating device 100 may include the induction coil 14. The induction coil 14 may surround the insertion space 24 and the heater 33. The induction coil 14 may cause the heater 33 to generate heat. The heater 33 may be a susceptor, which may generate heat by a magnetic field produced by an AC current flowing through the induction coil 14. The magnetic field may pass through the heater 33 to thereby generate an eddy current in the heater 33. The current may cause the heater 33 to generate heat.

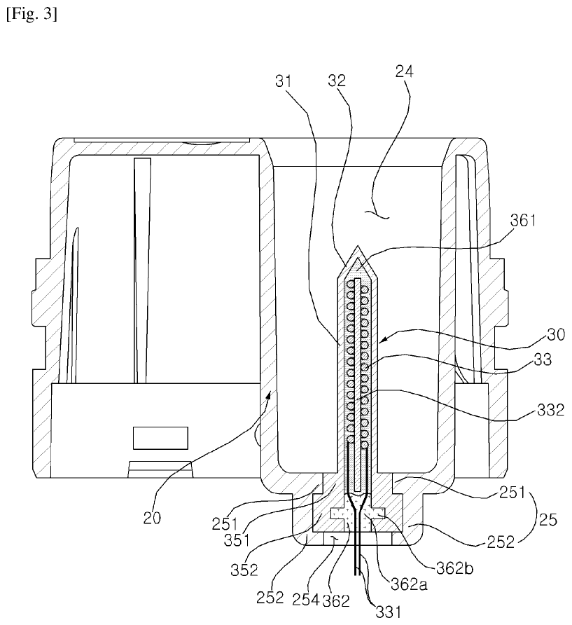

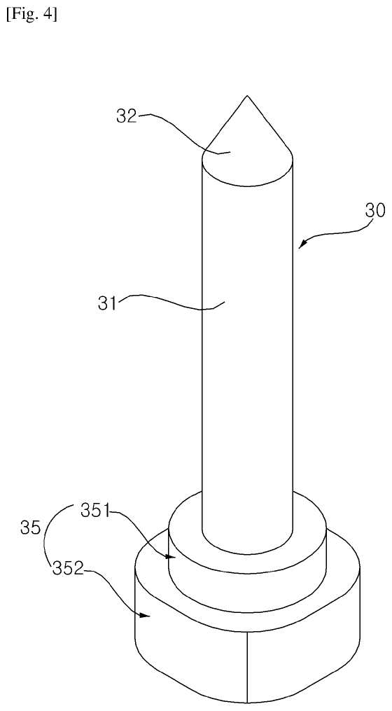

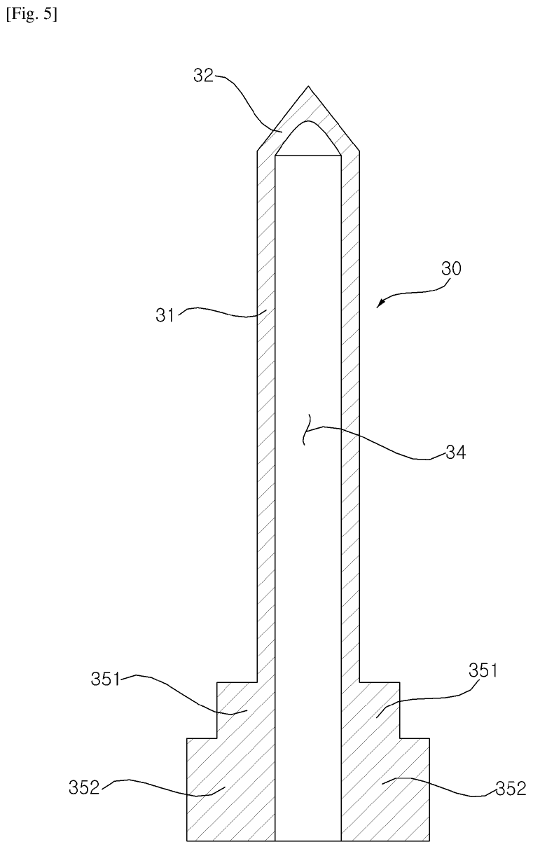

Referring to FIGS. 3 to 5, the pipe 20 may include a cover 25. The cover 25 may define a bottom of the pipe 20, and may cover a lower portion of the insertion space 24. The cover 25 may include a first cover part 251 and a second cover part 252.

The first cover part 251 may be connected to a lower end of the pipe 20. The first cover part 251 may cover a bottom of the insertion space 24. The second cover part 252 may be connected to the first cover part 251. The second cover part 252 may be formed under the first cover part 251. An inner surface of the second cover part 252 may be recessed outward relative to an inner surface of the first cover part 251. A cover hole 254 may be formed in a lower portion 2522 of the second cover part 252. The cover hole 254 may communicate with a cavity (or hollow) 34 of the heater pin 30.

The heater pin 30 may be elongated up and down or vertically. The heater pin 30 may protrude long upward from the cover 25 toward the insertion space 24. The heater pin 30 may include a cylindrical shape. The heater pin 30 may have a sharp or pointed upper end. The heater pin 30 may be provided therein with a space into which the heater 33 is inserted.

The heater pin 30 may be formed of a ceramic material. Since the heater pin 30 comes into contact numerous times with the stick 400 in a repeated manner, is elongated, and accommodates the heater 33 therein, the material of the heater pin 30 may be selected by considering mechanical strength, abrasion resistance, heat resistance, and moisture resistance. For example, the heater pin 30 may be formed of zirconia. Zirconia has the best mechanical strength at room temperature among the ceramics, a melting point of 2000 °C or more, and good hardness and wear resistance. Due to its excellent durability, the heater pin 30 may maintain a stable shape even under repeated heat generation of the heater 33 and repeated contact with the stick 400.

The heater pin 30 may include a pin body 31. The pin body 31 may be elongated vertically. The pin body 31 may have a cylindrical shape. An inside of the pin body 31 may define the cavity 34 (i.e., hollow). The heater pin 30 may be open at bottom to communicate with the cavity 34. The cavity 34 may be elongated vertically. The cavity 34 may have a cylindrical shape.

The heater pin 30 may include a pin tip 32. The pin tip 32 may define the upper end of the heater pin 30. The pin tip 32 may be integrally formed on the pin body 31. The pin tip 32 may have a shape that tapers upward. The pin tip 32 may have a sharp or pointed upper end. Accordingly, the heater pin 30 may pass through the stick S to thereby fix the stick S.

A flange 35 may protrude outward from the heater pin 30. The flange 35 may protrude from a lower end of the heater pin 30 in a lateral direction. The flange 35 may protrude from the heater pin 30 in a radially outward direction. The flange 35 may be integrally formed with the heater pin 30.

The flange 35 may be formed of a plurality of tiers. For example, the flange 35 may be formed of two tiers. For example, the flange 35 may include a first flange 351 and a second flange 352. The first flange 351 may be disposed at an upper portion (or top) of the flange 35. The second flange 352 may be disposed at a lower portion (or bottom) of the flange 35. Hereinafter, it will be described that the flange 35 includes the first flange 351 and the second flange 352. However, the present disclosure is not limited thereto, and the flange 35 may include a greater number of flanges. For example, the flange 35 may be formed of three or more tiers.

The first flange 351 may be disposed on the second flange 352. The first flange 351 may be integrally formed with the second flange 352. The first flange 351 may be disposed at a lower portion of the pin body 31. The first flange 351 may protrude from an outer circumferential surface of the pin body 31 in a laterally outward direction or the radially outward direction. The first flange 351 may extend in a circumferential direction.

The second flange 352 may be disposed underneath the first flange 351. The second flange 352 may be disposed at the lower end of the heater pin 30. The second flange 352 may protrude from the outer circumferential surface of the pin body 31 in the laterally outward direction or the radially outward direction. The second flange 352 may protrude further in the laterally outward direction or the radially outward direction than the first flange 351.

Accordingly, a step (or stepped portion) may exist between the first flange 351 and the second flange 352.

At least one of the first flange 351 and the second flange 352 may have a non-circular cross section. For example, the first flange 351 may extend in the circumferential direction to have a circular cross-sectional shape, and the second flange 352 may have a non-circular cross-sectional shape.

The first cover part 251 may surround and come into close contact with a lateral surface of the first flange 351. The first cover part 251 may cover or come into close contact with an upper surface of the second flange 352. An upper surface of the first flange 351, together with the first cover part 251, may face the bottom of the insertion space 24.

The second cover part 252 may surround and come into close contact with a lateral surface and an outer lower portion of the second flange 352. The second flange 352 may be disposed between the first cover part 251 and the second cover part 252 so as to be supported in an up-and-down direction or a vertical direction.

Accordingly, the cover 25 and the flange 35 may be coupled to each other to be engaged in the vertical direction so as to be supported in the vertical direction. Thus, separation of the heater pin 30 from the pipe 20 may be prevented, and the structural stability may be achieved.

In addition, the cover 25 and the flange 35 may be coupled to each other to be engaged in the circumferential direction. Accordingly, rotation of the heater pin 30 that is coupled to the pipe 20 may be prevented (see FIG. 3).

The pipe 20 may be formed by insert injection molding. A pipe 20 coupled with a heater pin 30 may be produced by inserting the heater pin 30, together with a heater 33, a support bar 332, and a bonding material 361, into a mold for injection of the pipe 20, then removing a lead wire 331 from the mold, and then injecting and solidifying an injection material into the mold.

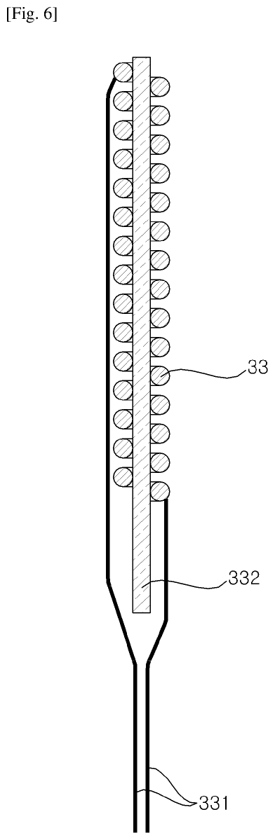

Referring to FIGS. 3 and 6, the heater 33 may have a coil shape. The heater 33 may be wound around a support bar 332 that is elongated. The heater 33 may be wound around the support bar 332 in a spiral shape. The support bar 332 may support the heater 33, allowing the heater 33 to be maintained in shape.

A lead wire 331 may extend long from each of both ends of the heater 33. The heater 33 may be supplied with power from a power source through the lead wire 331. The heater 33 may be a resistive heater, which may generate heat using power supplied thereto.

The heater 33 and the support bar 332 may be fixed inside the heater pin 30 by a bonding material 361. The bonding material 361 may cover the opening at the bottom of the heater pin 30. The lead wire 331 may pass through the bonding material 361 and the cover hole 254 so as to be exposed downward, and may be connected to the power source.

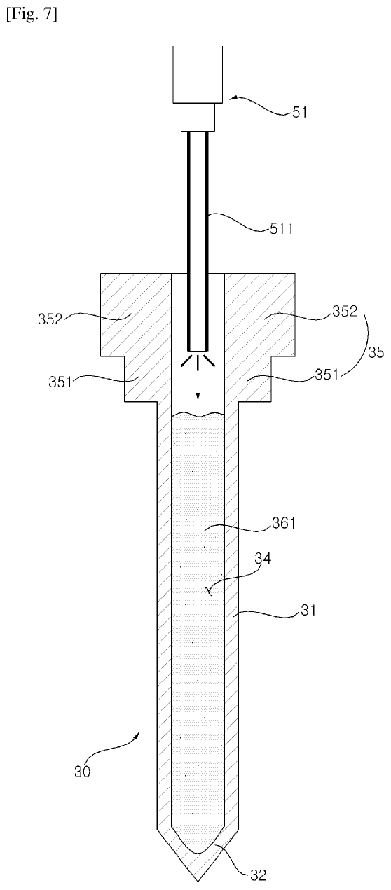

Referring to FIG. 7, an injector 51 may store therein the bonding material 361 in a liquid state. A nozzle 511 of the injector 51 may have an elongated shape. The injector 51 may spray the liquid-state bonding material 361 through the nozzle 511.

The bonding material 361 may be made of a material that is non-conductive and has excellent heat resistance and chemical resistance. For example, the bonding material 361 may be a ceramic bonding agent (ceramic bond). The ceramic bonding agent may include raw materials such as polyurethane, amine, styrene copolymer, resin, and the like, but the present disclosure is not limited thereto. The bonding material 361 in a liquid state may be solidified after a predetermined time at room temperature, but this may vary depending on the type of raw material constituting the bonding material 361 or the composition ratio of the raw materials. The bonding material 361 may be a ceramic bonding agent that has good compatibility with the heater pin 30 formed of ceramics, making it suitable for bonding the heater pin 30. Also, due to the excellent durability of the bonding material 361, the outer shape may be stably maintained even under repeated heat generation of the heater 33 and repeated contact with the stick 400.

The bonding material 361 may include an alumina ceramic, which may be a ceramic material containing aluminum oxide (Al—₂O₃) as a main component. For example, the content of aluminum oxide in the bonding material 361 may be 80% or more. Thus, the bonding material 361 may have high electrical insulation, high resistance to thermal shock, high thermal conductivity, and excellent mechanical adhesive strength and corrosion resistance. In addition, the bonding material 361 may be suitable for bonding and sealing an inside of the heater pin 30.

The heater pin 30 may be open at bottom. In a state where the heater pin 30 is turned upside down with the opening at the bottom of the heater pin 30 facing up, the bonding material 361 in a liquid state may be injected into the cavity 34 of the heater pin 30 through the injector 51. While being inserted into the cavity 34, the nozzle 511 may spray the bonding material 361 into the cavity 34. The bonding material 361 may be injected up to a height adjacent to the opening of the heater pin 30. For example, based on the heater pin 30 being turned upside down, the bonding material 361 may be injected up to a lower side of the flange 35.

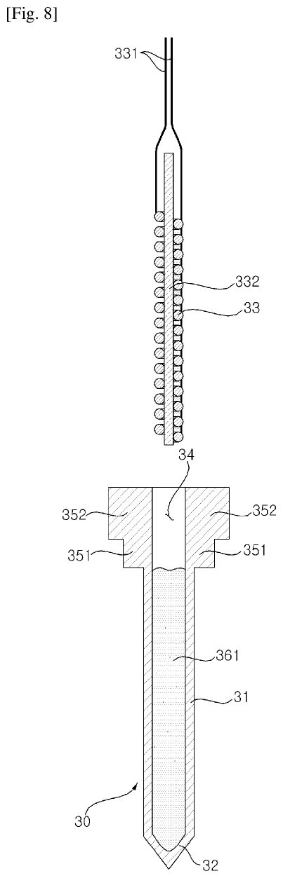

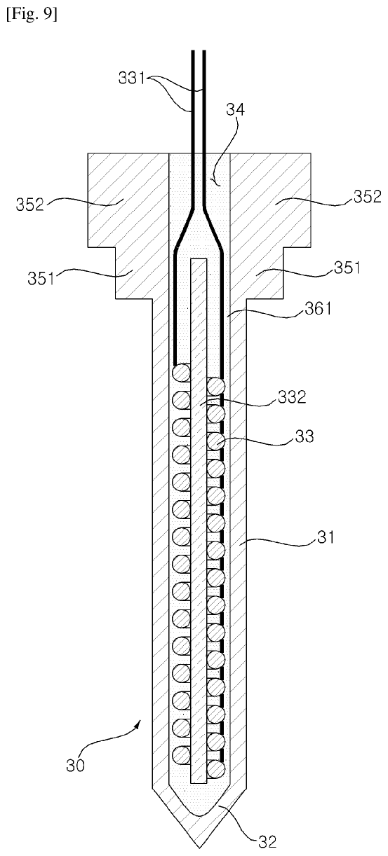

Referring to FIGS. 8 and 9, in a state where the heater pin 30 is turned upside down, the heater 33 and the support bar 332 may be inserted into the cavity 34 through the opening at the bottom of the heater pin 30. The heater 33 and the support bar 332 may be inserted into the liquid-state bonding material 361 injected into the cavity 34. The support bar 332 and the heater 33 may be completely submerged in the bonding material 361. As the heater 33 is wound around the support bar 332 and is supported by the support bar 332, the shape of the heater 33 may be maintained when inserted into the bonding material 361. Here, the lead wire 331 may extend from the heater 33 to an outside of the cavity 34 through the opening of the heater pin 30, so as to be exposed below the heater pin 30.

The support bar 332 may be disposed in the cavity 34 to be parallel with the pin body 31. The heater 33 may be disposed between the pin body 31 and the support bar 332 inside the cavity 34. The bonding material 361 may fill gaps among the pin body 31, the support bar 332, and the heater 33 in the cavity 34. After the heater 33 and the support bar 332 are inserted into the cavity 34, the bonding material 361 may be dried for a predetermined time and solidified into a solid state. The bonding material 361 may be bonded and fixed to an inner surface of the pin body 31. The bonding material 361 may be bonded and fixed to the heater 33 and the support bar 332. The bonding material 361 may fix or secure the heater 33 and the support bar 332 to the heater pin 30.

The support bar 332 may include aluminum oxide (Al—₂O₃). Aluminum oxide, which is one of the ceramic raw materials, has good rigidity, high electrical insulation, chemical stability, good corrosion resistance and heat resistance, and low price. Due to its electrical insulation properties, the support bar 332 may be prevented from being short-circuited with the heater 33, and may allow the heater 33 to be securely fixed with almost no shape deformation when the heater 33 generates heat. In addition, as the support bar 332 has good compatibility with the bonding material 361, the support bar 332 may be easily bonded with the bonding material 361.

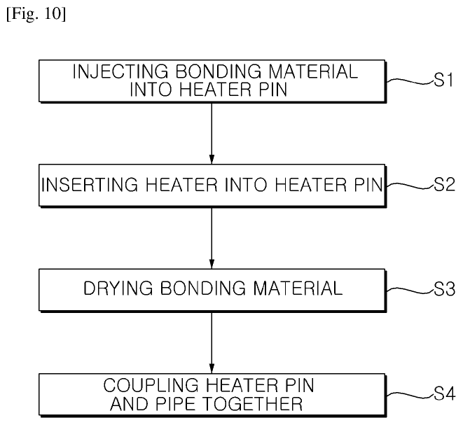

Referring to FIG. 10, according to an exemplary embodiment, a method of manufacturing an aerosol generating device may include injecting a bonding material 361 into a heater pin 30 (S1). In a state where a cavity 34 and an opening of the heater pin 30 are turned upside down to face upward, a nozzle 511 of an injector 51 may be inserted into the cavity 34 to inject the bonding material 361 (see FIG. 7). Here, the bonding material 361 may be in a liquid state.

The method of manufacturing the aerosol generating device may include inserting a heater 33 into the cavity 34 of the heater pin 30 (S2). At step S2, when the bonding material 361 is in a liquid state, the heater 33 may be inserted into the cavity 34 and the bonding material 361 to be submerged in the bonding material 361 (see FIGS. 7 to 9). Alternatively, while the heater 33 is inserted into the cavity 34, the bonding material 361 in a liquid state may be injected into the cavity 34. Here, the heater 33 may be inserted together with a support bar 332 into the cavity 34. As the heater 33 is wound around the support bar 332, the heater 33 may be stably maintained in shape and be accurately positioned when inserted into the liquid-state bonding material 361.

The method of manufacturing the aerosol generating device may include drying the bonding material 361 in a liquid state (S3). Here, the liquid-state bonding material 361 may be dried into a solid state to thereby be fixed to the heater pin 30, allowing the heater 33 and the support bar 332 inside to be fixed to the heater pin 30.

The method of manufacturing the aerosol generating device may include coupling the heater pin 30 and a pipe 20 together (S4). Here, the pipe 20 may be formed by insert injection molding. The pipe 20 coupled with the heater pin 20 may be produced by inserting the heater pin 30, together with the heater 33, the support bar 332, and the bonding material 361, into a mold for injection of the pipe 20, then removing a lead wire 331 from the mold, and then injecting and solidifying an injection material into the mold.

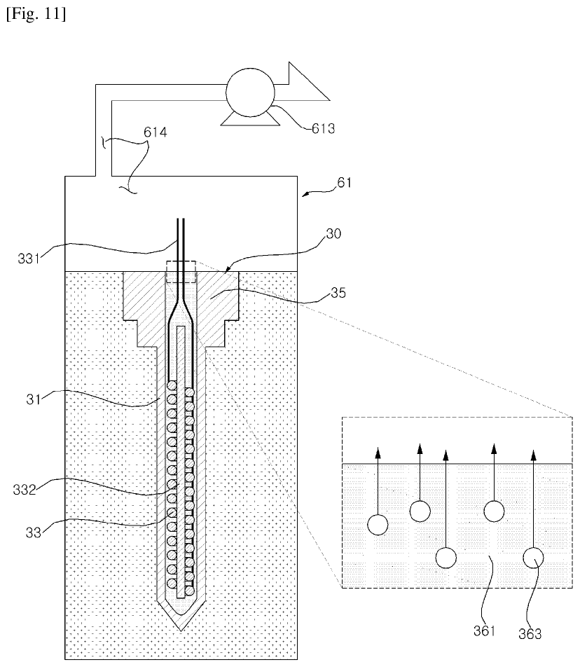

Referring to FIGS. 11 to 20, in the case of an aerosol generating device including a heater pin 30 that has a cavity 34 therein and is open on one side, and a heater 33 that is inserted into the cavity 34, a method of manufacturing the aerosol generating device may further include a step of reducing bubbles 363 in a bonding material 361 in a liquid state. The step of reducing the bubbles 363 in the bonding material 361 in the liquid state may be performed after injecting the liquid-state bonding material 361 into the heater pin 30 and before solidifying the bonding material 361 into a solid state.

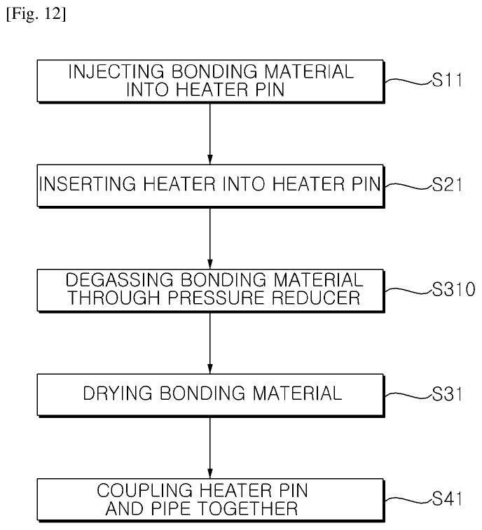

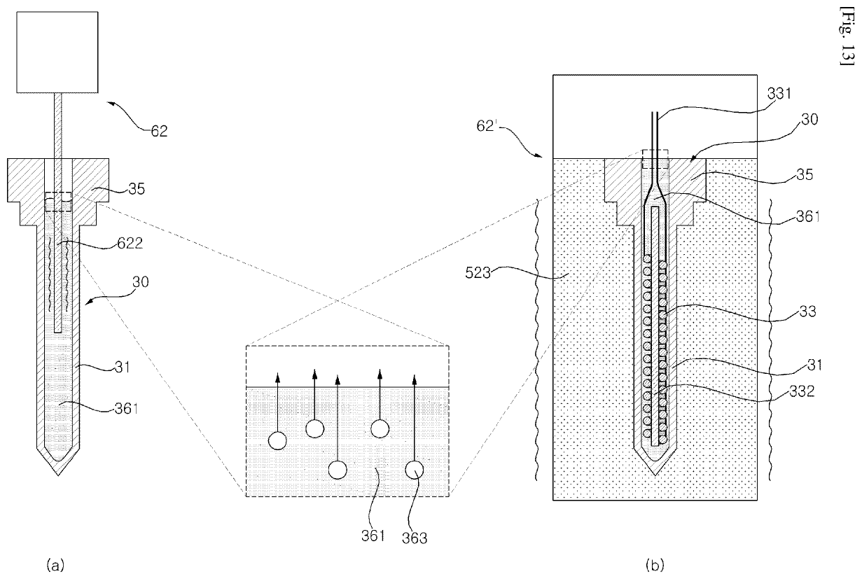

Referring to FIGS. 11 and 12, the step of reducing the bubbles 363 in the bonding material 361 in the liquid state may include degassing the bonding material 361 through a pressure reducer (S310). A method of manufacturing the aerosol generating device may include: injecting a bonding material 361 into the heater pin 30 (S11); inserting the heater 33 into the heater pin 30 (S21); degassing the bonding material 361 through a pressure reducer 61 (S310); drying the bonding material 361 (S31); and coupling the heater pin 30 and a pipe 20 together (S41).

In one example, the degassing of the bonding material 361 through the pressure reducer 61 (S310) may be performed after the injecting of the bonding material 361 in a liquid state into the heater pin 30 (S11). In another example, the degassing of the bonding material 361 through the pressure reducer 61 (S310) may be performed after the injecting of the bonding material 361 in a liquid state into the heater pin 30 (S11) and the inserting of the heater 33 into the heater pin 30 (S21).

In detail, the degassing of the bonding material 361 through the pressure reducer 61 (S310) may be performed by placing the heater pin 30 to an inside 614 of the pressure reducer 61, then providing a communication between an opening of the heater pin 30 and the inside 614 of the pressure reducer 61, and then reducing pressure of the inside 614 of the pressure reducer 61, thereby removing bubbles 363 from the bonding material 363. Here, the opening of the heater pin 30 may be disposed to face upward. The pressure reducer 613 may be a pressure reducing valve or a decompression pump.

The pressure reducer 61 may be a decompression desiccator. Accordingly, the pressure reducer 61 may perform both the step of reducing the bubbles 363 and the step of solidifying the bonding material 361 into a solid state. When the pressure reducer 61 is a decompression desiccator, the degassing of the bonding material 361 through the pressure reducer 61 (S310) may be performed after the injecting of the bonding material 361 in a liquid state into the heater pin 30 (S11) and the inserting of the heater 33 into the heater pin 300 (S21).

Thus, the formation of a void, which may occur when the bubble 363 of the bonding material 361 is not removed and hardens inside the heater pin 30, may be reduced, and the efficiency of conduction of heat generated from the heater 33 may be improved. In addition, water, due to voids, may be prevented from entering the inside of the heater pin 30. Further, the structural stability of a heater assembly may be improved.

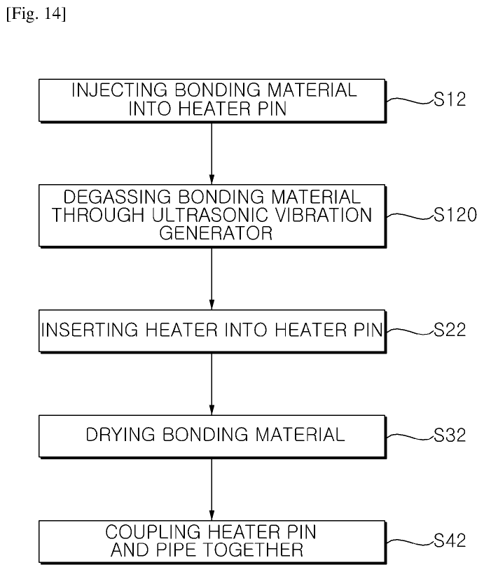

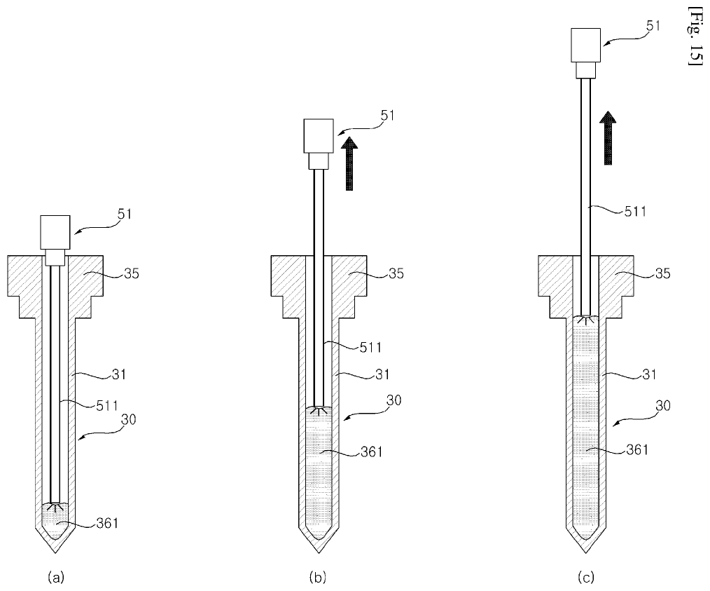

Referring to FIGS. 13 and 14, the step of reducing the bubbles 363 in the bonding material 361 in the liquid state may include degassing the bonding material 361 through an ultrasonic vibration generator (62, 62′) (S120). A method of manufacturing the aerosol generating device may include injecting a bonding material 361 into the heater pin 30 (S12); degassing the bonding material 361 through an ultrasonic vibration generator 62, 62′ (S120); inserting the heater 33 into the heater pin 30 (S22); drying the bonding material 361 (S32); and coupling the heater pin 30 and a pipe 20 together (S42).

In one example, the degassing of the bonding material 361 through the ultrasonic vibration generator 62, 62′ (S120) may be performed after the injecting of the bonding material 361 in a liquid state into the heater pin 30 (S12). In another example, the degassing of the bonding material 361 through the ultrasonic vibration generator 62, 62′ (S120) may be performed after the injecting of the bonding material 361 in a liquid state into the heater pin 30 (S12) and the inserting of the heater 33 into the heater pin 30 (S22).

In one implementation, a first ultrasonic vibration generator 62 may be configured to cause the bonding material 361 to ultrasonically vibrate by inserting a vibrating rod 622 of an elongated bar shape into the bonding material 361 in a liquid state ((a) of FIG. 13). Here, the degassing of the bonding material 361 through the ultrasonic vibration generator 62 (S120) may be performed before the inserting of the heater 33 into the heater pin 30 (S22).

In another implementation, a second ultrasonic vibration generator 62′ may be configured to accommodate the heater pin 30 therein to cause the heater pin 30 to ultrasonically vibrate ((b) of FIG. 13). This is merely an example, and the form or type of the ultrasonic vibration generator (62, 62′) is not limited thereto, and other forms may be used so long as to cause the bonding material 361 to ultrasonically vibrate.

Thus, the formation of a void, which may occur when the bubble 363 of the bonding material 361 is not removed and hardens inside the heater pin 30, may be reduced, and the efficiency of conduction of heat generated from the heater 33 may be improved. In addition, water, due to voids, may be prevented from entering the inside of the heater pin 30. Further, the structural stability of the heater assembly may be improved.

Alternatively, the second ultrasonic vibration generator 62′ and the decompression desiccator 61 may be included in a single device, which may be referred to as an ultrasonic decompression desiccator. The ultrasonic decompression desiccator may be configured to accommodate the heater pin 30 therein. By using the ultrasonic decompression desiccator, the following steps may be performed simultaneously: causing the bonding material 361 in the heater pin 30 to ultrasonically vibrate; degassing bubbles in the bonding material 361 through internal pressure reduction; and drying the bonding material 361. Thus, the manufacturing process may be shorter and more efficient.

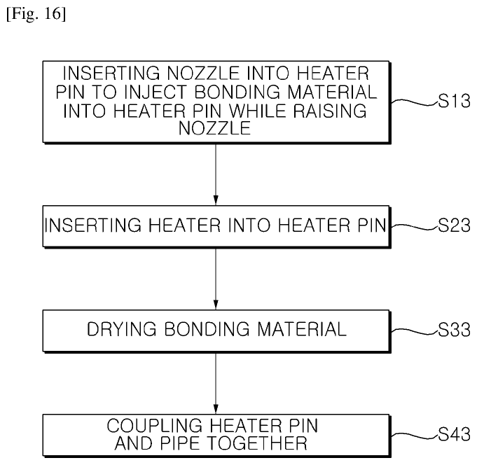

Referring to FIGS. 15 and 16, the step of reducing the bubbles 363 in the bonding material 361 in the liquid state may be performed in the step of injecting the bonding material 361. The bubbles 363 in the bonding material 361 may be reduced depending on how the bonding material 361 is injected.

In the step of reducing the bubbles 363 in the bonding material 361 in the liquid state, the bonding material 361 may be injected in a manner that discharges the bonding material 361 by inserting a nozzle 511 into the cavity 34 in the heater pin 30 (S13). Here, the bonding material 361 may be discharged while raising the nozzle 511 corresponding to a height of the bonding material 361 increased as the bonding material 361 is injected (S13) (see (a), (b), and (c) of FIG. 15).

A method of manufacturing the aerosol generating device may include injecting a bonding material 361 into the heater pin 30 while raising a nozzle 511 (S13); inserting the heater 33 into the heater pin 30 (S23); drying the bonding material 361 (S33); and coupling the heater pin 30 and a pipe 20 together (S43).

In the injecting of the bonding material 361 into the heater pin 30 while raising the nozzle 511 (S13), the bonding material 361 may be discharged while raising the nozzle 511 corresponding to a height of the bonding material 361. Here, the height of the bonding material 361 and a height of an end of the nozzle 511 may correspond to each other.

Accordingly, when the bonding material 361 is sprayed from the nozzle 511, the amount of bubble 363 formation in the bonding material 361 may be reduced. Thus, the formation of a void, which may occur when the bubble 363 of the bonding material 361 is not removed and hardens inside the heater pin 30, may be reduced, and the efficiency of conduction of heat generated from the heater 33 may be improved. In addition, water, due to voids, may be prevented from entering the inside of the heater pin 30. Further, the structural stability of the heater assembly may be improved.

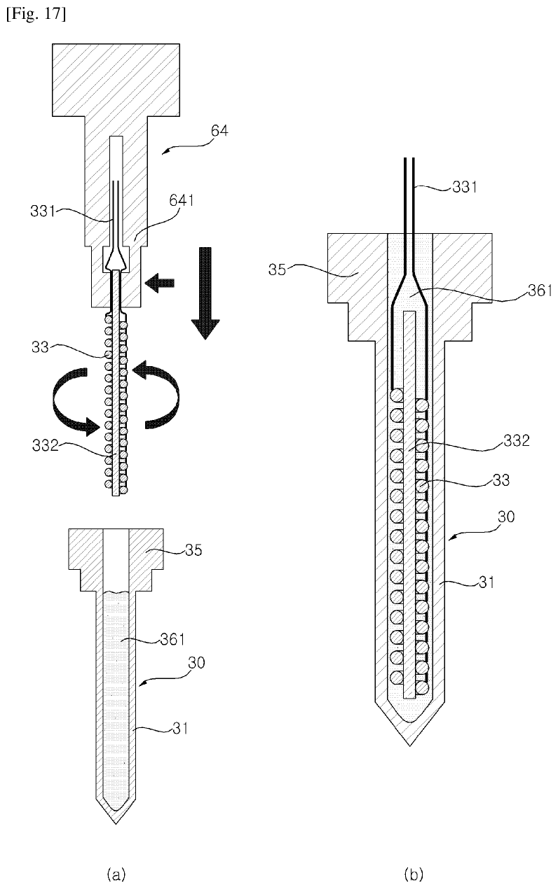

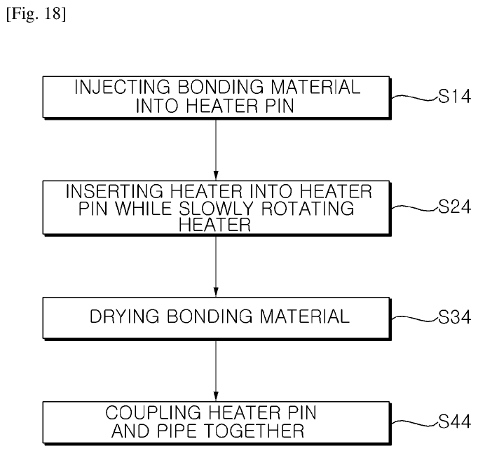

Referring to FIGS. 17 and 18, the step of reducing the bubbles 363 in the bonding material 361 in the liquid state may be performed in the step of inserting the heater 33. The bubbles 363 in the bonding material 361 may be reduced depending on how the heater 33 is inserted into the bonding material 361.

A method of manufacturing the aerosol generating device may include: injecting a bonding material 361 into the heater pin 30 (S14); inserting the heater 33 into the heater pin 30 by slowly rotating the heater 33 (S24); drying the bonding material 361 (S34); and coupling the heater pin 30 and a pipe 20 together (S44).

The inserting of the heater 33 into the heater pin 30 by rotating the heater 33 (S24) may be performed by inserting while rotating the heater 33 and the support bar 332 in a direction in which the heater 33 is wound. When the heater 33 and the support bar 332 are inserted into the bonding material 361 without rotation, an air layer may be formed between the bonding material 361 and the heater 33 and the support bar 332 in the cavity 33 upon insertion, causing bubbles 363 to be formed in the bonding material 361.

As the heater 33 is wound in a spiral shape, when the heater 33 is inserted into the bonding material 361 while being rotated in a direction in which the heater 33 is wound, the bonding material 361 in a liquid state may spirally flow upward along the heater 33 of a coil shape to thereby reduce the formation of the air layer. Also, the formation of a bubble between coils may be reduced. For the rotatable insertion of the heater 33, the heater 33 and the support bar 332 may be inserted into the bonding material 261 by holding and rotating the heater 33 and the support bar 332 through a rotation mechanism 64.

Meanwhile, when the heater 33 is inserted at a high speed, bubbles 363 may be generated due to collision between the bonding material 361 and the heater 33 or between the bonding material 361 and the support bar 332. Therefore, the heater 33 may be slowly inserted at a speed that does not cause the formation of bubbles 363 in the bonding material 361. The speed that does not cause the formation of bubbles 363 may vary depending on the size or shape of the support bar 332 and the heater 33, and the property or amount of the bonding material 361. An appropriate speed may be measured through experiments. For example, the speed that does not cause the formation of bubbles 363 may be a speed at which bubbles 363 are generated less than 2% of the volume of the bonding material 361.

Accordingly, the formation of a bubble between coils may be reduced, which is caused when the liquid-state bonding material 361 flows upward along the heater 33 of the coil shape. Thus, the formation of a void, which may occur when the bubble 363 of the bonding material 361 is not removed and hardens inside the heater pin 30, may be reduced, and the efficiency of conduction of heat generated from the heater 33 may be improved. In addition, water, due to voids, may be prevented from entering the inside of the heater pin 30. Further, the structural stability of the heater assembly may be improved.

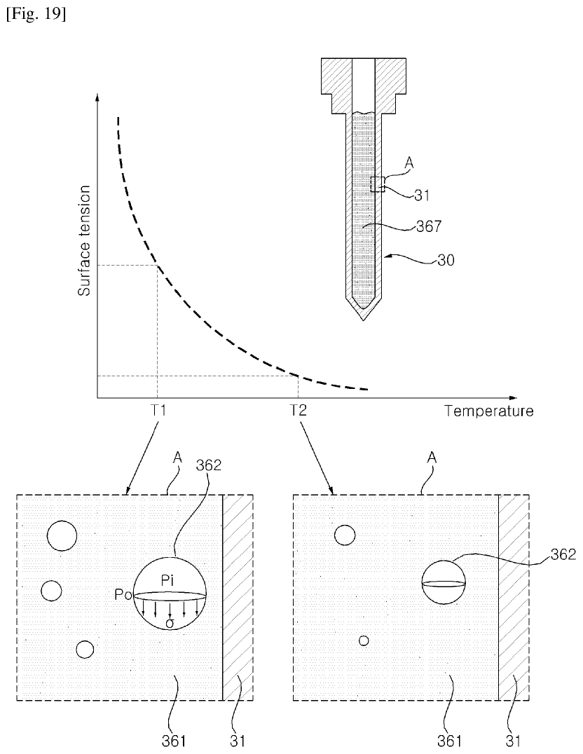

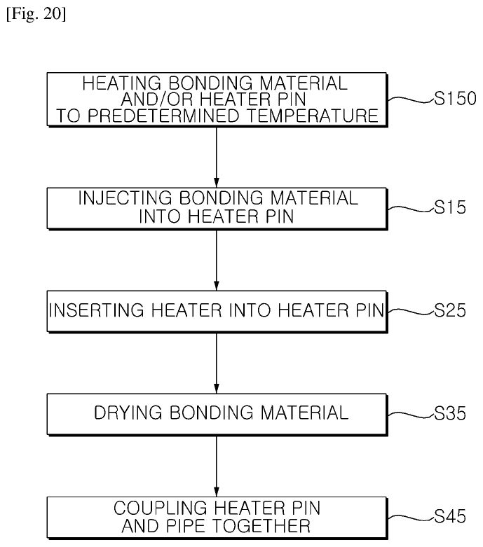

Referring to FIGS. 19 and 20, the surface tension of a liquid may vary with temperature, and the surface tension of a liquid may decrease as the temperature of the liquid increases. The surface tension may determine the size of a bubble. The relationship between the size of a bubble in a liquid and the surface tension may be expressed by the following equation:

Pᵢ−Pₒ=4σ/r

(Pᵢ: pressure inside bubble, Pₒ: pressure outside bubble, σ: surface tension, and r: radius of bubble)

That is, the surface tension of a liquid decreases as the temperature of the liquid increases, and the size of a bubble in the liquid may decrease as the surface tension decreases.

In order to reduce the bubbles 363 in the bonding material 361, a method of manufacturing the aerosol generating device may directly or indirectly increase the temperature of the bonding material 361. The method of manufacturing the aerosol generating device may include heating the bonding material 361 and/or the heater pin 30 to a predetermined temperature (S150). The method of manufacturing the aerosol generating device may include: injecting a bonding material 361 into the heater pin 30 (S15); inserting the heater 33 into the heater pin 30 (S25); drying the bonding material 361 (S35); and coupling the heater pin 30 and a pipe 20 together (S45).

The heating of the bonding material 361 and/or the heater pin 30 to the predetermined temperature (S150) may be performed before the drying of the bonding material 361 (S35). In one example, the heating of the bonding material 361 and/or the heater pin 30 to the predetermined temperature (S150) may be performed before or after the injecting of the bonding material 361 into the heater pin 30 (S15). In another example, the heating of the bonding material 361 and/or the heater pin 30 to the predetermined temperature (S150) may be performed after the inserting of the heater 33 into the heater pin 30 (S25). The heating of the bonding material 361 and/or the heater pin 30 to the predetermined temperature (S150) may be performed, for example, by placing and heating the heater pin 30 with the bonding material 361 injected therein in a temperature chamber. However, the present disclosure is not limited thereto.

Accordingly, the formation of a void, which may occur when the bubble 363 of the bonding material 361 is not removed and hardens inside the heater pin 30, may be reduced, and the efficiency of conduction of heat generated from the heater 33 may be improved. In addition, water, due to voids, may be prevented from entering the inside of the heater pin 30. Further, the structural stability of the heater assembly may be improved.

Referring to FIGS. 1 to 20, according to an aspect of the present disclosure, there is provided a method of manufacturing an aerosol generating device including a heater inserted into an elongated heater pin. The method includes: injecting a bonding material in a liquid state into a cavity of the heater pin; inserting the heater into the cavity; reducing bubbles in the bonding material while the bonding material is still in the liquid state; and solidifying the bonding material into a solid state to secure the heater in the heater pin.

The reducing of the bubbles may include degassing the bonding material using a pressure reducer.

The method further includes reducing pressure above the bonding material using the pressure reducer to cause bubbles to escape from the inside of the bonding material.

The pressure reducer may be a decompression desiccator configured to cause both the reducing of the bubbles and solidifying of the bonding material into the solid state.

The reducing of the bubbles may include degassing the bonding material using an ultrasonic vibration generator.

The ultrasonic vibration generator may be configured to cause ultrasonic vibrations in the bonding material via an elongated vibrating rod inserted into the bonding material.

The ultrasonic vibration generator may be configured to accommodate the heater pin therein to cause the heater pin to ultrasonically vibrate.

The reducing of the bubbles may include: degassing the bonding material using an ultrasonic decompression desiccator including an ultrasonic vibration generator and a decompression desiccator.

The injecting of the bonding material includes reducing the bubbles by inserting a nozzle of an elongated injector into the cavity of the heater pin for injecting the bonding material.

The bonding material is injected into the cavity while gradually raising the nozzle to correspond to a rising level of the bonding material as the bonding material is injected.

The nozzle may be gradually raised such that an end of the nozzle matches the level of the bonding material as the bonding material is injected.

The heater may be wound around an elongated support bar which is inserted into the cavity.

The inserting of the heater may include reducing the bubbles by inserting the heater into the bonding material while rotating the heater in a direction in which the heater is wound around the support bar.

The heater may be inserted into the bonding material at a speed that does not cause formation of a bubble in the bonding material.

The method may further include heating at least one of the heater pin or the bonding material to a predetermined temperature.

Certain embodiments or other embodiments of the disclosure described above are not mutually exclusive or distinct from each other. Any or all elements of the embodiments of the disclosure described above may be combined with another or combined with each other in configuration or function.

For example, a configuration “A” described in one embodiment of the disclosure and the drawings, and a configuration “B” described in another embodiment of the disclosure and the drawings may be combined with each other. Namely, although the combination between the configurations is not directly described, the combination is possible except in the case where it is described that the combination is impossible.

Although embodiments have been described with reference to a number of illustrative embodiments thereof, it should be understood that numerous other modifications and embodiments can be devised by those skilled in the art that will fall within the scope of the principles of this disclosure. More particularly, various variations and modifications are possible in the component parts and/or arrangements of the subject combination arrangement within the scope of the disclosure, the drawings, and the appended claims. In addition to variations and modifications in the component parts and/or arrangements, alternative uses will also be apparent to those skilled in the art.

1. A method of manufacturing an aerosol generating device comprising a heater inserted into an elongated heater pin, the method comprising:
injecting a bonding material in a liquid state into a cavity of the heater pin;
inserting the heater into the cavity;
reducing bubbles in the bonding material while the bonding material is still in the liquid state; and
solidifying the bonding material into a solid state to secure the heater in the heater pin.

2. The method of claim 1, wherein the reducing of the bubbles comprises degassing the bonding material using a pressure reducer.

3. The method of claim 2, further comprising reducing pressure above the bonding material using the pressure reducer to cause bubbles to escape from the inside of the bonding material.

4. The method of claim 3, wherein the pressure reducer is a decompression desiccator configured to cause both the reducing of the bubbles and solidifying of the bonding material into the solid state.

5. The method of claim 1, wherein the reducing of the bubbles comprises degassing the bonding material using an ultrasonic vibration generator.

6. The method of claim 5, wherein the ultrasonic vibration generator is configured to cause ultrasonic vibrations in the bonding material via an elongated vibrating rod inserted into the bonding material.

7. The method of claim 5, wherein the ultrasonic vibration generator is configured to accommodate the heater pin therein to cause the heater pin to ultrasonically vibrate.

8. The method of claim 1, wherein the reducing of the bubbles comprises: degassing the bonding material using an ultrasonic decompression desiccator comprising an ultrasonic vibration generator and a decompression desiccator.

9. The method of claim 1, wherein injecting of the bonding material includes reducing the bubbles by inserting a nozzle of an elongated injector into the cavity of the heater pin for injecting the bonding material.

10. The method of claim 9, wherein the bonding material is injected into the cavity while gradually raising the nozzle to correspond to a rising level of the bonding material as the bonding material is injected.

11. The method of claim 10, wherein the nozzle is gradually raised such that an end of the nozzle matches the level of the bonding material as the bonding material is injected.

12. The method of claim 1, wherein the heater is wound around an elongated support bar which is inserted into the cavity.

13. The method of claim 12, wherein inserting of the heater includes reducing the bubbles by inserting the heater into the bonding material while rotating the heater in a direction in which the heater is wound around the support bar.

14. The method of claim 12, wherein the heater is inserted into the bonding material at a speed that does not cause formation of a bubble in the bonding material.

15. The method of claim 1, further comprising heating at least one of the heater pin or the bonding material to a predetermined temperature.
